(19) United States
(12) Patent Application Publication
(10) Pub. No.: US 2013/0018954 A1
(43) Pub. Date: Jan. 17, 2013

(54) SITUATION-AWARE USER SENTIMENT SOCIAL INTEREST MODELS

(71) Applicant: Doreen CHENG, San Jose, CA (US)

(72) Inventor: Doreen CHENG, San Jose, CA (US)

(73) Assignee: SAMSUNG ELECTRONICS CO., LTD., Suwon City (KR)

(21) Appl. No.: 13/406,430

(22) Filed: Feb. 27, 2012

Related U.S. Application Data
(60) Provisional application No. 61/508,492, filed on Jul. 15, 2011.
(60) Provisional application No. 61/508,968, filed on Jul. 18, 2011.

(51) Int. Cl. G06F 15/16

(52) U.S. Cl. 709/204

(57) ABSTRACT

A method for constructing user models from user usage and context data is provided where a personal interest graph for a user is constructing from interests of the user derived from usage data and situational data derived from one or more sensors of the electronic device. The nodes in the interest graph also contain information about a degree of user interest in the corresponding interest and a sentiment of the user at the time when the usage data suggests that the user expressed interest in the interest graph. The personal interest graph can be modified by annotating one or more nodes of the personal interest graph with influence information. Later, a current sentiment for the user can be determined by analyzing input from one more sensors on the electronic device, and a particular node can be located in the personal interest graph based on the information in the nodes.

### CROSS REFERENCE TO RELATED APPLICATIONS

This application claims the benefit of priority under 35 U.S.C. §119(e) to U.S. Provisional Patent Application No. 61/508,492, filed on Jul. 15, 2011, and U.S. Provisional Patent Application No. 61/508,968, filed on Jul. 18, 2011, both of which are incorporated herein by reference in its entirety for all purposes.

### BACKGROUND OF THE INVENTION

1. Field of the Invention

The present invention relates generally to user modeling. More specifically, the present invention relates to using situation-aware user sentiment social interest models.

2. Description of the Related Art

A social networking service is an online service, platform, or site that focuses on building and reflecting of social networks or social relations among people, who share a common link, such as, for example, shared interests and/or activities. A social network service includes a representation of each user (often a profile), his/her social links, and a variety of additional services. Most social network services are web-based and provide means for users to interact over the Internet, such as e-mail and instant messaging. Social networking sites allow users to share ideas, activities, events, and interests within their individual networks.

The main types of social networking services are those that contain category places (such as former school year or classmates), means to connect with friends (usually with self-description pages), and a recommendation system linked to trust. Many sites now combine more than one of these.

Social networking sites have profoundly changed how people socially interact with each other, opening opportunities for businesses as well as individual users. Consumers can now be constantly connected to their friends and contacts, sharing statuses, information, and content. In near real-time, they can monitor news, events, and discussions that are happing anywhere in the world.

Meanwhile, the amount of online content and information available is undergoing another explosion. This explosion further exacerbates the frustrations of already overwhelmed consumers, since the majority of the content and information is irrelevant to a particular user at a particular moment. More than ever before, consumers are longing for a solution that would put the information they need or things they like at their fingertips when they need them. On the other hand, businesses have accumulated an astronomical amount of data detailing consumers' online activities. It is commonly recognized that mining the data to understand consumers' interests and sentiments can enable better targeted marketing and advertisement.

Some companies have been developing analytics to extract consumer's interest and sentiments from data. The majority of these efforts focus on deriving the trends and sentiments of a large population for business purposes such and marketing and investment. On the other hand, some businesses have been developing analytics for modeling the interests of individual consumers as interest graphs.

The main weakness of all these efforts is their blindness about the user's situation. At a particular moment, what a user needs or likes and what is appropriate to suggest to the user can be highly variable based upon the user's situation. For example, even though a user may like good wine, suggesting going to a wine tasting nearby may not be a good idea when his friends with him at the time do not like wine. In another example, a user may enjoy going to theaters, visiting museums, and hiking, but which if these activities to suggest depends greatly on the weather, the users mood, and on whether of her friends who share a same interest are available.

While improving recommendation is important on any computing platform, it is especially important for devices with small form factors such as mobile phones, due to small display areas, lower processing speed, and more limited user input.

In addition to the above weaknesses, prior art solutions also suffer because recommendations based simply on the online activities of a friend, e.g., based on a friend's online purchase of merchandise or a friend's click on a “like” button of an item only work well if the friend shares the same interests as the user. Most friends, however, only share interests in some domains (e.g., like the same wine, but have different television viewing habits). For highly relevant recommendations, what is needed is a system that understands which domain the users share interests, and yet prior art approaches do not take domain into account.

Furthermore, prior art solutions suffer because they do not adequately consider who influences a user's decision making process. Simply taking recommendations from social networking site friends is likely to result in less relevant recommendations because for many users, the majority of the social networking site “friends” are not actually friends, but merely contacts. Furthermore, in addition to close friends, users are typically also influenced by experts, celebrities, and other consumers who made similar choices, and these entities are not reflected in social networking site “friends”. Lastly, users are more likely to trust domain experts in certain areas than their friends, such as medical, technical, legal, and other knowledge-intensive areas.

### SUMMARY OF THE INVENTION

In a first embodiment of the present invention, a method of constructing user models from user usage and context data is provided, the method comprising: constructing a personal interest graph including interests derived from usage data of the electronic device, with nodes of the personal interest graph representing interests of the user, and wherein the nodes also contain information about a degree of user interest in the corresponding interest and a sentiment of the user at the time when the usage data suggests that the user expressed interest in the interest, wherein the sentiment is determined by analyzing input from one or more sensors on the electronic device; modifying the personal interest graph by annotating one or more nodes of the personal interest graph with influence information, wherein the influence information contains a pointer to another user who influences the user on the interest represented by the corresponding node and a degree of influence of the another user on the user for this interest; determining a current sentiment for the user by analyzing input from one more sensors on the electronic device; and locating a node that contains a sentiment that is similar to the current sentiment and that has the highest combination of degree of user interest.

In a second embodiment of the present invention, an electronic device is provided comprising: a situation-aware user activity tracker including: a situation data gathering and pre-processing module; an activity data gathering and pre-processing module; a situation name space component; a situation analysis module; a user model construction/update module including: a social modeling component; an interest modeling component; an influence analysis module; a sentiment analysis module; a natural language programming semantic analysis module; and a data storage coupled to the situation-aware user activity tracker and the user model construction/update module.

In a third embodiment of the present invention, an apparatus is provided comprising: means for constructing a personal interest graph including interests derived from usage data of the electronic device, with nodes of the personal interest graph representing interests of the user, and wherein the nodes also contain information about a degree of user interest in the corresponding interest and a sentiment of the user at the time when the usage data suggests that the user expressed interest in the interest, wherein the sentiment is determined by analyzing input from one or more sensors on the electronic device; means for modifying the personal interest graph by annotating one or more nodes of the personal interest graph with influence information, wherein the influence information contains a pointer to another user who influences the user on the interest represented by the corresponding node and a degree of influence of the another user on the user for this interest; means for determining a current sentiment for the user by analyzing input from one more sensors on the electronic device; and means for locating a node that contains a sentiment that is similar to the current sentiment and that has the highest combination of degree of user interest.

In a fourth embodiment of the present invention, a non-transitory program storage device readable by a machine tangibly embodying a program of instructions executable by the machine to perform a method of constructing user models from user usage and context data is provided, the method comprising: constructing a personal interest graph including interests derived from usage data of the electronic device, with nodes of the personal interest graph representing interests of the user, and wherein the nodes also contain information about a degree of user interest in the corresponding interest and a sentiment of the user at the time when the usage data suggests that the user expressed interest in the interest, wherein the sentiment is determined by analyzing input from one or more sensors on the electronic device; modifying the personal interest graph by annotating one or more nodes of the personal interest graph with influence information, wherein the influence information contains a pointer to another user who influences the user on the interest represented by the corresponding node and a degree of influence of the another user on the user for this interest; determining a current sentiment for the user by analyzing input from one more sensors on the electronic device; and locating a node that contains a sentiment that is similar to the current sentiment and that has the highest combination of degree of user interest.

### BRIEF DESCRIPTION OF THE DRAWINGS

FIG. 1 is a flow diagram illustrating a method for defining situations in accordance with an embodiment of the present invention.

FIG. 2 is a diagram illustrating a high-level architecture in accordance with an embodiment of the present invention.

FIG. 3 is a diagram illustrating tracking situation usage history in accordance with an embodiment of the present invention.

FIG. 4 is a diagram illustrating the output of relationship analysis in accordance with an embodiment of the present invention.

FIG. 5 is a diagram illustrating the output of interest modeling in accordance with an embodiment of the present invention.

FIG. 6 is a diagram illustrating the output of interest analysis in accordance with an embodiment of the present invention.

FIG. 7 is a diagram illustrating the output of sentiment analysis in accordance with an embodiment of the present invention.

FIG. 8 is a diagram depicting an example of a multiuser model in accordance with an embodiment of the present invention.

FIG. 9 is a diagram illustrating the overall process of user model generation in accordance with an embodiment of the present invention.

FIG. 10 depicts recommendation in accordance with an embodiment of the present invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

The present invention provides a solution where user interests and social networking preferences can be modeled in various situations. Additionally, the present invention provides a solution where the user model can be influenced by others when making decisions in various domains and situations, as well as how a user can influence other users in various domains.

A situation may be defined as the values of a set of variables that affect and sometimes determine a user's preference, behaviors, and decision making. Generally speaking, a situation can be defined by one or more of the following categories of variables: (1) variables that define a physical environment (e.g., location, time, weather, sound, lighting, etc.); (2) variables that define a social circumstance (e.g., people around the user, category of venue the user is in, etc.); (3) variables that define a user state (e.g., mood, emotion, heart rate, blood pressure, glucose level, etc.); and (4) variables that define user activity (e.g., physical activities such as walking, driving, sleeping, dancing, etc., and online activities such as email, phone calls, shopping, social networking, web surfing, viewing and interacting with content, etc.).

Data values of some variables can be gathered using hardware sensors, e.g., GPS, microphone, heart rate monitor, etc. Values for other variable may be gathered using software sensors such as weather and power state of a mobile device, and user's social circumstance.

Not all variables need to be used in defining a situation. Roughly speaking, which variables are important in defining situations will vary from one application domain to another application domain. For example, selecting a piece of music to listen to could mainly depend on the user's mood, activity, and people around, while other variables are less important or not important at all. What variables are important can also vary from one user to another. For example, for one user weather may be an important factor in deciding what activity to perform, but not for other users.

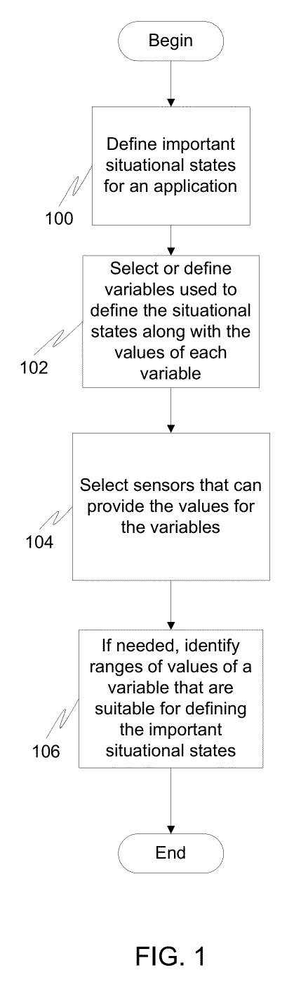

FIG. 1 is a flow diagram illustrating a method for defining situations in accordance with an embodiment of the present invention. This method may be performed by, for example, an application designer. At 100, important situational states for an application are defined. For example, for a music recommender, one situational state may be “outside, afternoon, running, alone, low stress”, with another being “at home, evening, sitting, sad, with others, high stress.” A situation name space can be defined to support the selection of the situation names and the usage of the names in situation-aware user modeling.

At 102, variables used to define the situational states are selected or defined, along with the values of each variable. In the music example, the variables can be time, location, mood, physical activity, and social environment. At 104, sensors that can provide the values for the variables can be selected. For example, the application designer may indicate that time can be tracked via a clock, location is tracked via a GPS module, mood is tracked by a heart rate monitor, etc. Of course, any particular variable can be linked to more than one sensor. For example, physical activity may be tracked using a combination of GPS, accelerometer, and gyroscope. Additionally, the sensors may be software in nature.

At 106, if needed, ranges of the values of a variable that are suitable for defining the important situational states are identified. For example, instead of exact time, values such as “morning, noon, afternoon, evening, and night” may be more appropriate for some applications.

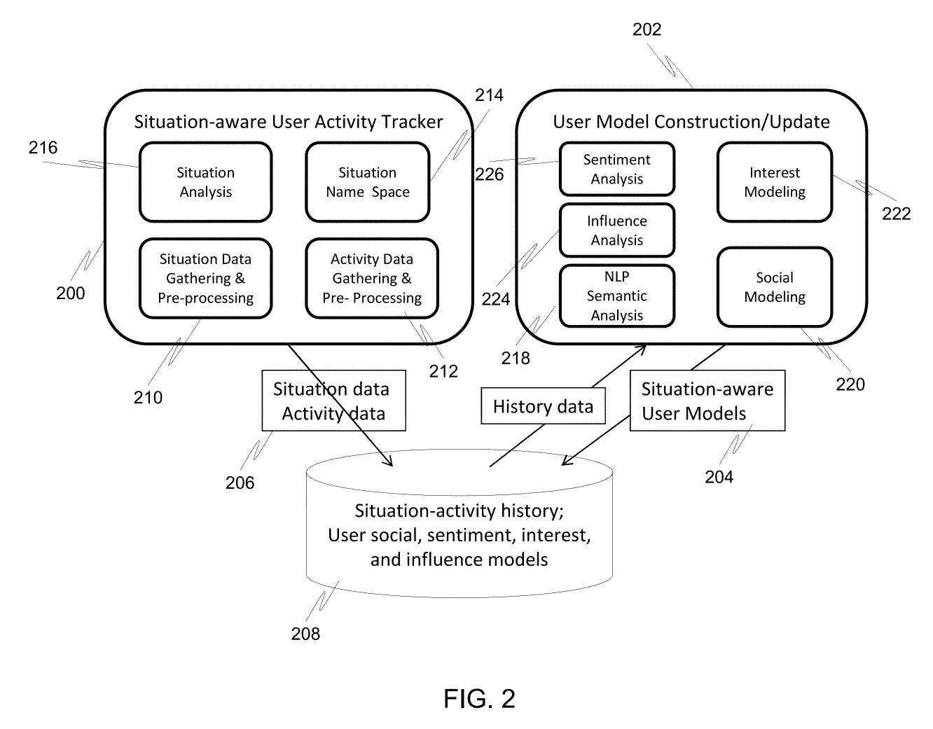

FIG. 2 is a diagram illustrating a high-level architecture in accordance with an embodiment of the present invention. The architecture contains two main parts. A situation-aware user activity tracker 200 logs user usage activity data and corresponding situation data at the time of the usage. A usage activity means a user interaction with a device and application, such as a browser, social networking applications, phone call application, email, SMS, calendar, etc. A user model construction/update module 202 builds and updates user models. When to update and how frequently to update the models can be user-configurable. In a simpler case, the output of the system is a set of models 204 about the user's relationship, interests, who influences the user about a topic, whom the user influences about a topic, and the user's sentiments towards a topic/concept or person. When the user's situation 206 is taken into account, the use's relations, interests, influences, and sentiments can all be annotated with the situation or situations in which they apply in storage 208.

The situation-aware user activity tracker 200 may include a number of components. A situation data gathering and pre-processing module 210 gathers the data of the variables that are selected to define the situations. The selection may be performed by a designer of the application that will use the models to better serve the user, as described earlier. Examples of preprocessing that may be performed by this component include scaling, reducing noise, correcting errors, handling missing data, etc. Depending on the situation definition, more complex data processing may be needed. For example, machine learning algorithms can be used to identify user physical activity and physiological state from the data gathered from the wearable sensors, such as accelerometers and galvanic skin response sensors.

An activity data gathering and pre-processing module 212 may collect the data about user usages of a device, typically through an application such as a browser, email, SMS program, social networking application, e-commence, phone call app, etc. Examples of usage include updating a profile, adding/deleting friends, tweets/retweets, likes, shares, recommends, clicks, online posts, etc. The raw data often needs to be transformed and stored, preferably without losing much information. The stored data can be structured, such as database data, semi-structured, such as XML, or unstructured, such as raw text. Optionally, this component can preprocess the gathered data, such as through encryption for privacy reasons. Designers may wish to choose which data items are to be collected based on the application domain that the system is designed to server. Designers may also want to take the cost of storage and computation time into account when selecting the data items.

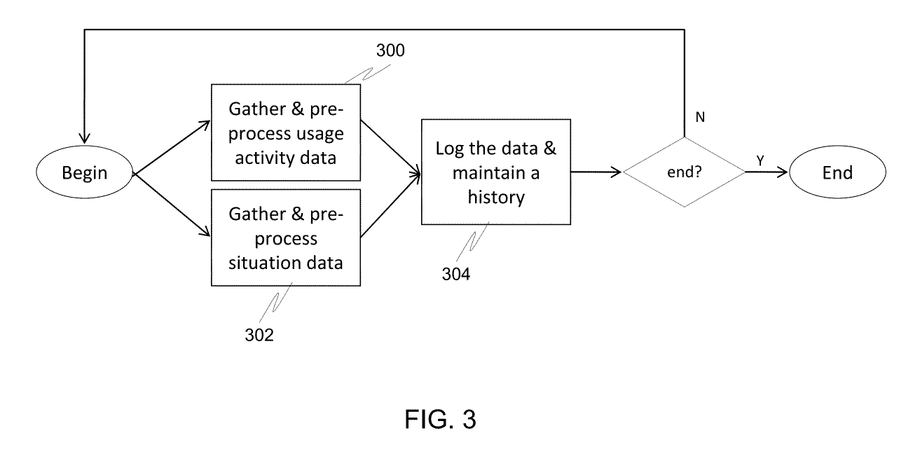

FIG. 3 is a diagram illustrating tracking situation usage history in accordance with an embodiment of the present invention. As can be seen, usage activity data 300 and situation data 302 can be gathered and pre-processed as a pair. Then the pair can be logged 304, which may include time stamping, and stored in usage history in storage. The raw data can be gathered from one or more devices used by the user to access/interact with the web or Internet, such as phones, televisions, tablets, computers, and smart home devices. The software on these devices can be instrumented for gathering the data of interest. The data can be processed and stored in various places, such as in a cloud, on a home server, or on a computer, or distributed on various connected devices.

Referring back to FIG. 2, a situation name space component 214 manages the names/models of high-level situation concepts and the mapping between the name of a situation and the values of the variables that define the situation. The names and the mappings of the situations that are common to many use cases are preferably defined for the entire system. Situation names may contain variables that can be filled at runtime. For example, the X in the situation “in a meeting, near X” is to be replaced at runtime by the name of a location;/attraction, such as “in a meeting, near Stanford University.” In addition, the situation names may be concatenated to form the name of a new situation. For example, “in a meeting” can be concatenated with “with John, Jean” and become “in a meeting with John, Jean.” Additional operations supported by this component include browsing, querying, modifying, adding, deleting the names and the mappings.

A situation analysis module 216 analyzes the preprocessed situation data and derives the situation best represented by the data. The derivation may contain one or more steps of data fusion, e.g., deriving that the user is dancing from one or more accelerometers, deriving that the user is happy from mood sensors, and deriving that the user is with friends in a party from social sensors and a microphone. Supervised algorithms can be used for this derivation. At each step of the derivation, the component queries the situation name space for the proper name of the situation given the situation data at hand.

Turning to the user model construction/update module 202, a Natural Language Processing and semantic analysis module 218 provides various services and a semantic framework including ontology for analyzing natural language texts. A simple example of such services is the extraction of terms from a text, disambiguating the terms, and providing the semantic meanings for the terms. This can be used, for example, to analyze the calendar entries and emails of a user to extract scheduled event names, time periods, places, and people attending the event.

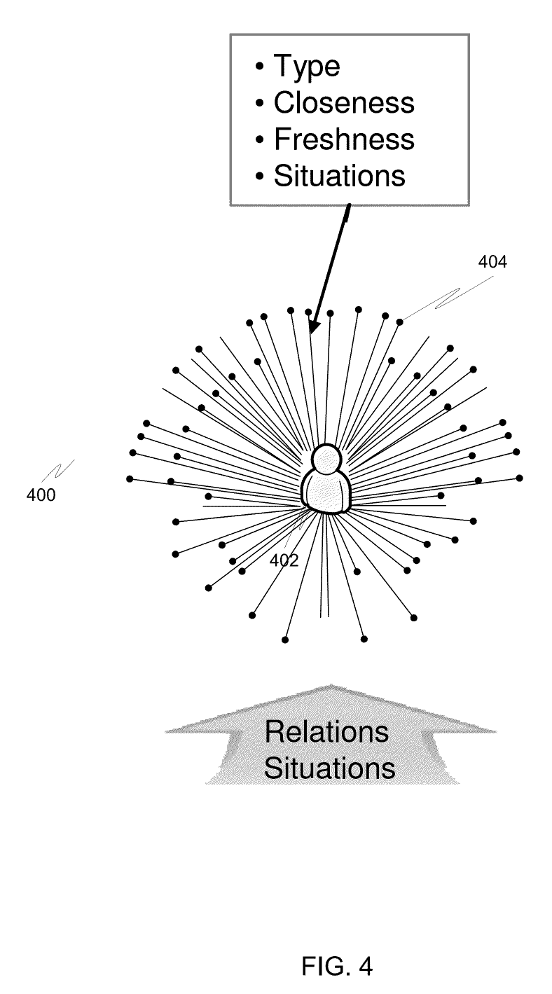

A social modeling component 220 analyzes the data from user activities at various online social networking sites and builds a social graph that represents the user's relationship with his or her friends. FIG. 4 is a diagram illustrating the output of relationship analysis in accordance with an embodiment of the present invention. User social relations can be modeled as a social graph 400 where a node 402 represents a person, and an edge between two nodes (e.g., 402, 404) indicates that the people are socially related. These edges may be directional, such that a directional edge from node A to node B indicates that person A considers person B as a friend or follows person B. An edge can then be annotated with information about the relations, including the type of the relationship, e.g., family, colleague, friend, etc., closeness computed e.g., using the frequency of direct interaction between the two people, and freshness, e.g., a value that decays over time if there are no interactions between the two people. An edge may also be annotated with situations to indicate situational preferences of friendship. For example, when Jane is happy and energetic, she likes to be with Joe and Kate, when she is sad or stressed out, she likes to be with Ann and Bob.

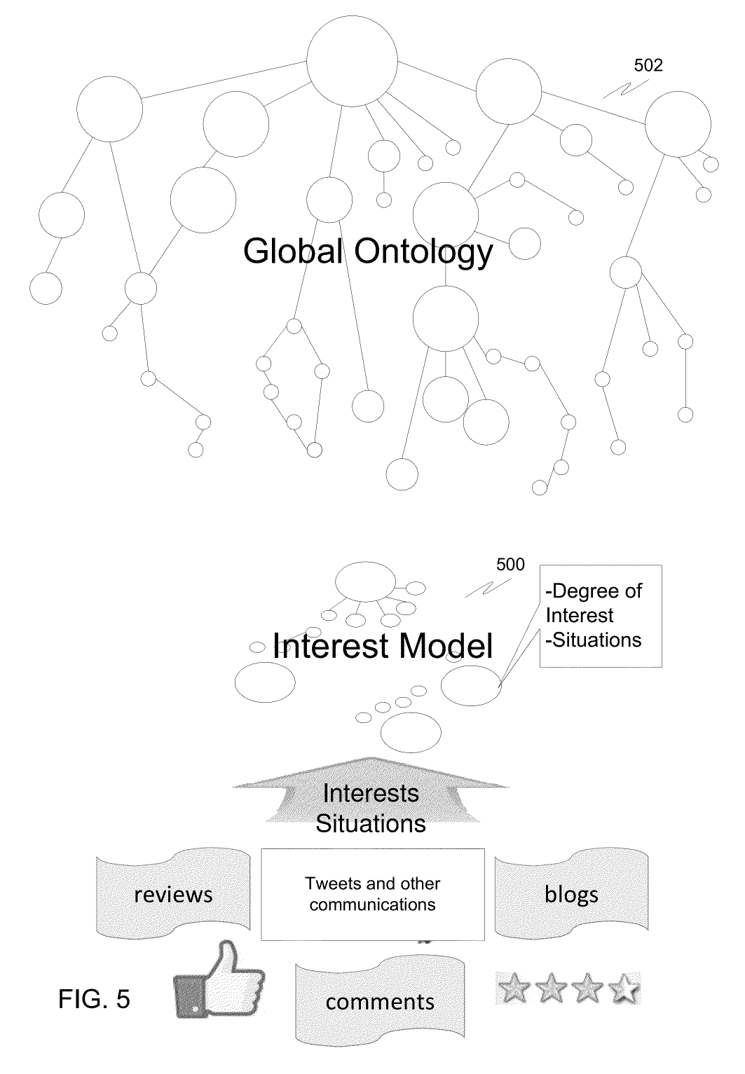

Referring back to FIG. 2, an interest modeling component 222 builds user interest models and updates them as needed. FIG. 5 is a diagram illustrating the output of interest modeling in accordance with an embodiment of the present invention. The interest model can be stored as a weighed concept graph, which can be a personalized subset 500 of a global ontology 502 maintained by the Natural language Processing and semantic analysis module of FIG. 2, and is typically much smaller than the global ontology 502. A node of the personal interest graph 500 represents a concept and an edge connecting two concept nodes represents the ontological relationship between the concepts. The personal interest graph 500 can be constructed as a separate ontology that is a subset of the global ontology. In this case, the concept names and the ontological relationships of the concepts in the interest graphs can be consistent with the global ontology. A designer can choose one or more sub-trees as a user's interest graph. For example, the designer can choose entertainment with only movie and music sub-trees. Alternatively, it can be constructed as personal links to the global ontology. Situations can also be taken into account.

If a designer chooses to construct a personal interest graph as a separate subset of the global ontology, a node in the personal interest graph may carry the information that indicates the situations in which the user has expressed interests in the concept. The concepts can be extracted by analyzing the data associated with a user activity, such as text of a user's online posts. The concepts can also be extracted from the data associated with an advertisement the user clicked or shared, an item the user bought, rated, reviewed, shared, recommended, etc. Links in the posts may be followed and the text may also be analyzed to extract the interest concepts. A node may also carry the information to indicate the degree of a user's interest about the concept represented by the node. A simple way of computing the degree of interest is to increase it when a user had a positive interaction with an item represented by the concept. Examples of positive interactions are clicks of a like, share, or recommend button of the item. The computation of the degree can also take into account the user's sentiment expressed towards a concept.

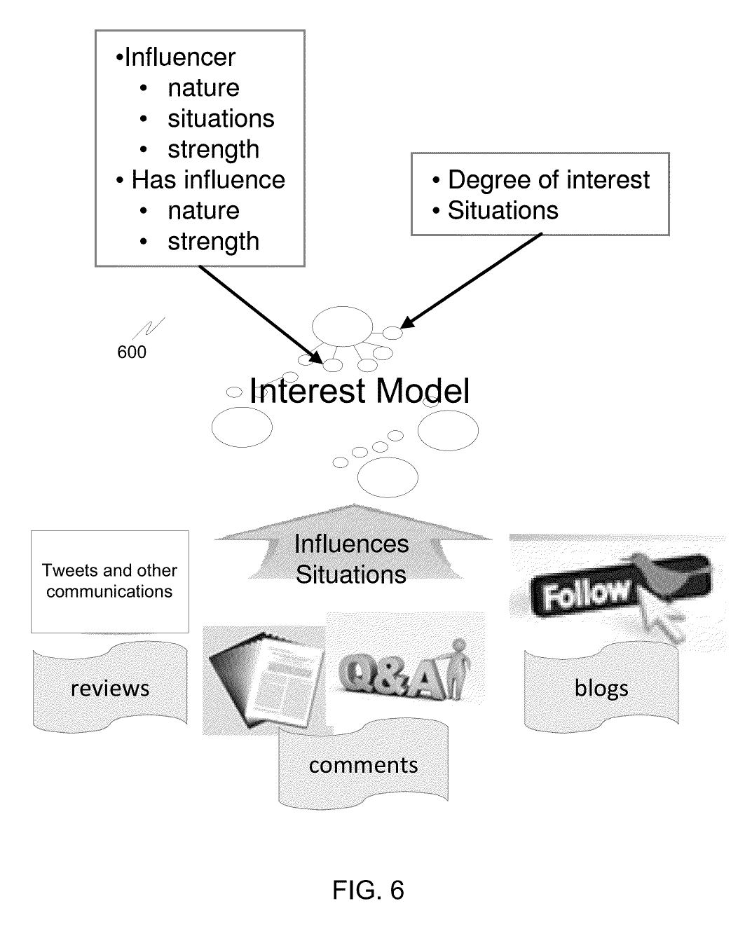

Referring back to FIG. 2, an influence analysis module 224 identifies who influences the user in various products, brand names, and topical areas in various situations. FIG. 6 is a diagram illustrating the output of interest analysis in accordance with an embodiment of the present invention. The results can be stored as a graph 600 that overlays on top of the user's interest graph. When the personal interest graph is constructed as separate subset ontology, a node of the interest graph can be annotated with influence information. Influence information contains a pointer to the influencer who influences the user on the topic or concept represented by the node, as well as information about the type of influence, the strength of the influence, and the situation in which the influence occurred. The user name or ID of the influencer can be used as the pointer. The influencers and the topics can be found by analyzing the social activities such as following, tweeting, etc. and their associated text. Examples of the type of influence include positive, neutral, and negative. The type of an influence can also be identified by analyzing user sentiments towards the influencer and the concept represented by the node. Examples of the strength are strong, medium, and weak. In addition, the analysis can also capture the information about the topical areas where the user influences the other users and how strong the influence is. The areas of influence can be similarly extracted from the user's online posts such as web pages, blogs, answers to questions, reviews, etc. The strength of the influence can be computed by the number of posts he/she has published, the number of his/her followers, and rating of the posts by the other users. The results can also be stored in the node of the interest graph. Situation can also be taken into account.

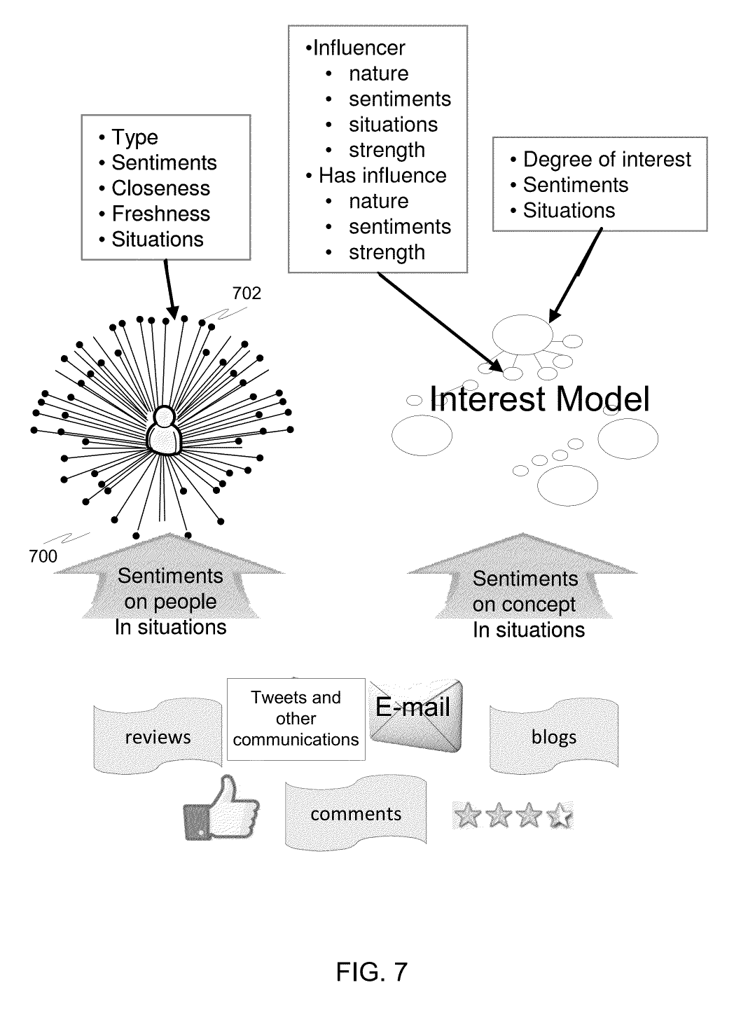

Referring back to FIG. 2, a sentiment analysis module 226 can compute the user's sentiments about people and concepts in various situations. The results can also be stored as a graph that overlays on top of the user's interest graph. FIG. 7 is a diagram illustrating the output of sentiment analysis in accordance with an embodiment of the present invention. In cases where the personal interest graph 700 is constructed as a separate subset ontology, a node 702 of the interest graph can be annotated with the sentiment information about the concept represented by the node. Examples of sentiment information include the types and the strengths of user's sentiments and the situation in which such sentiments are expressed. Examples of sentiment types include positive, neutral, and negative. Sentiment types can also include user emotion, such as happy, angry, sad, afraid, etc. User sentiments can be obtained by tracking user actions such as clicks of a like, share, or recommend button. They can also be obtained by analyzing the texts associated with user online activities such as blogs, emails, tweets, reviews, comments, etc. using an existing sentiment analysis algorithm, e.g. domain-independent sentiment analysis (an example of which is described in a thesis entitled “Identifying and Isolating Text Classification Signals from Domain and Genre Noise for Sentiment Analysis” by Justin Martineau, http://ebiquity.umbc.edu/paper/html/id/580). When the user expressed sentiments toward a person, the sentiment information can be recorded in the personal social graph, for example by annotating the edge linking the user to the person.

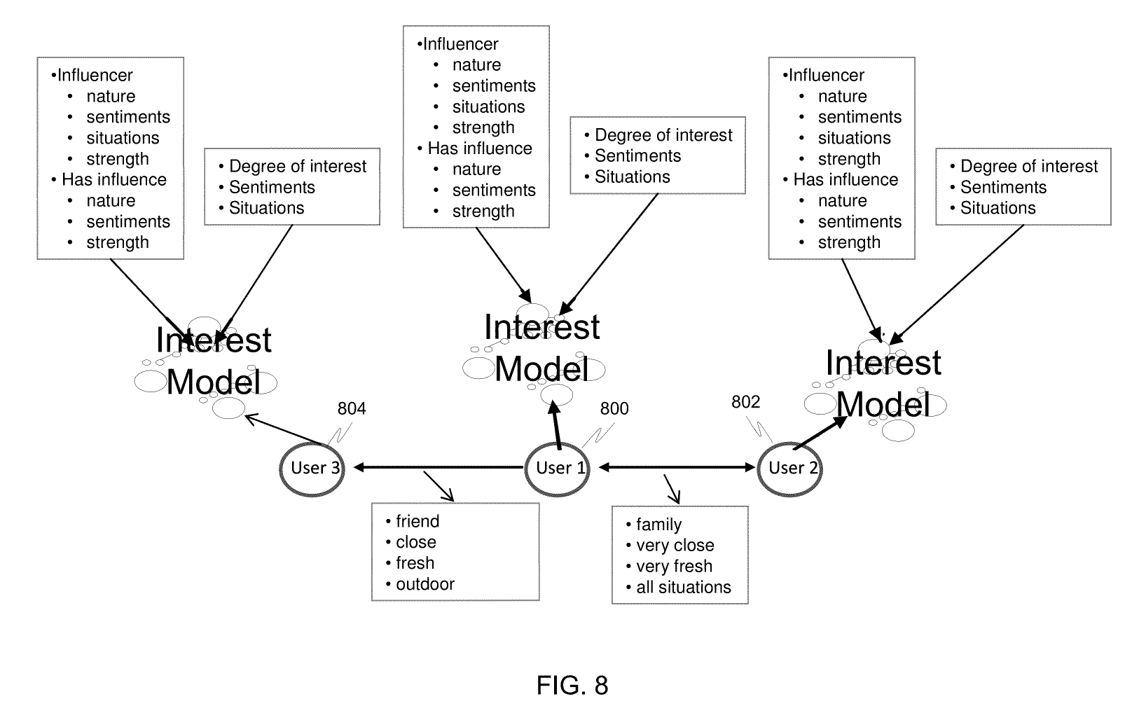

FIG. 8 is a diagram depicting an example of a multiuser model in accordance with an embodiment of the present invention. User 1 800 and user 2 802 are family and user 1 800 considers user 3 804 as a friend but not the reverse. Each edge is annotated with the characteristics of the relation. Each node representing a user has a link to his/her interest model (such as model 806 for user 1 800), each of which is derived from a global ontology. Each node of the interest model is also annotated with the characteristics, including situation, influence, and sentiments.

A node in the interest graph can also carry the information about the freshness of the interest. One way to measure freshness is to set the freshness to a pre-defined level every time the user expresses his or her interest in the concept, and let the freshness gradually decay over time if there are no further indications over this period of time. The freshness information can be used to determine whether a concept should be deleted from the user's interest graph. Computation time and storage used may be reduced by keeping only active interests in the graph.

As an alternative embodiment, the designer can choose to construct a personal interest graph as a set of personal interest links to the global ontology, instead of being constructed as a separate subset of a global ontology. In this case, when the user expresses interest on a concept for the first time, a link will be added to connect the user's node in the social graph to the concept node in the global ontology. All the information computed above about the user's interests, sentiments, and influences, including situation information and freshness information can be recorded on the link to the corresponding concept.

The personal sentiment social and interest graphs built above can then be directly used by applications, such as for predicting user needs, for making recommendations, and for decision making. Machine learning/data mining algorithms can be applied to the data in order to find latent patterns. These algorithms can also be used to extract a user's longer-term interests and social relations. They can also be used to find other users with similar tastes. The latent patterns, the longer-term interests, situation-independent interests, and interests of similar users can then be used for serendipitous recommendations.

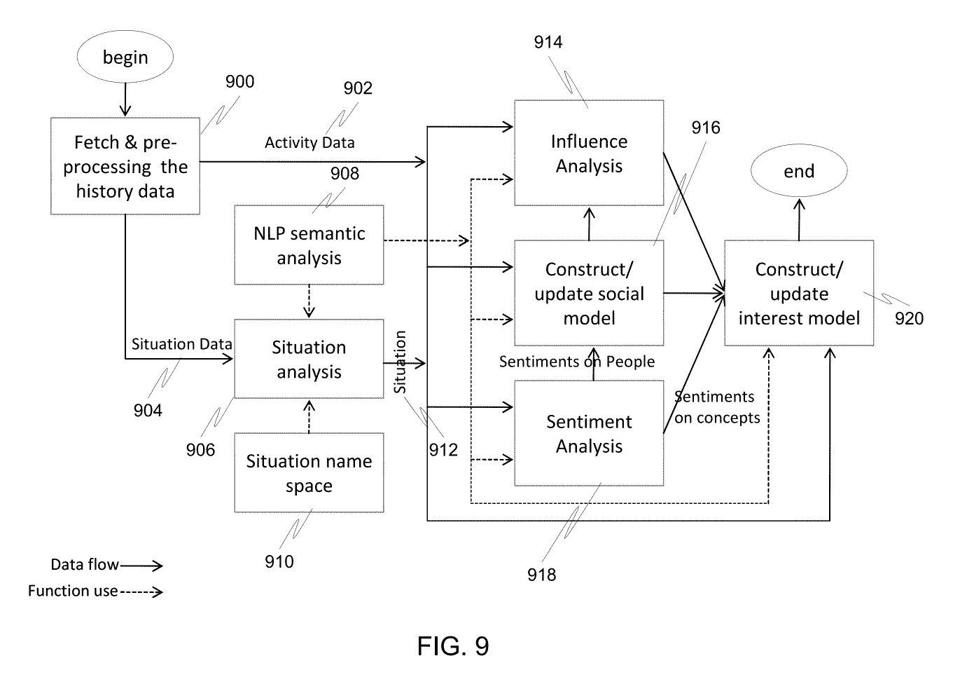

FIG. 9 is a diagram illustrating the overall process of user model generation in accordance with an embodiment of the present invention. It should be noted that the components shown in this figure are many of the same components shown in FIG. 2, and as such, the discussion of FIG. 2 above is applicable here as well. At 900, history data is fetched and pre-processed. This history data can be parsed into activity data 902 and situation data 904. The situation data 904 is fed to a situation analysis component 906 that determines the situation (s) corresponding to the activities in the activity data 902. It may use natural language processing and semantic analysis 908 and a predefined situation name space 910 as part of this process. The result is identified situations 912 corresponding to the activity data 902. Both situation and activity data are fed to three modules, influence analysis 914, construct/update social model 916, and sentiment analysis 918. Influence analysis, sentiment analysis, social model construction, as well as situation analysis may use the natural language and semantic analysis component. The outputs of these components can then be used to construct or update the user interest model 920, e.g. sentiments on concepts can be used for updating the interest model, whereas sentiment on people can be used for updating user's social model.

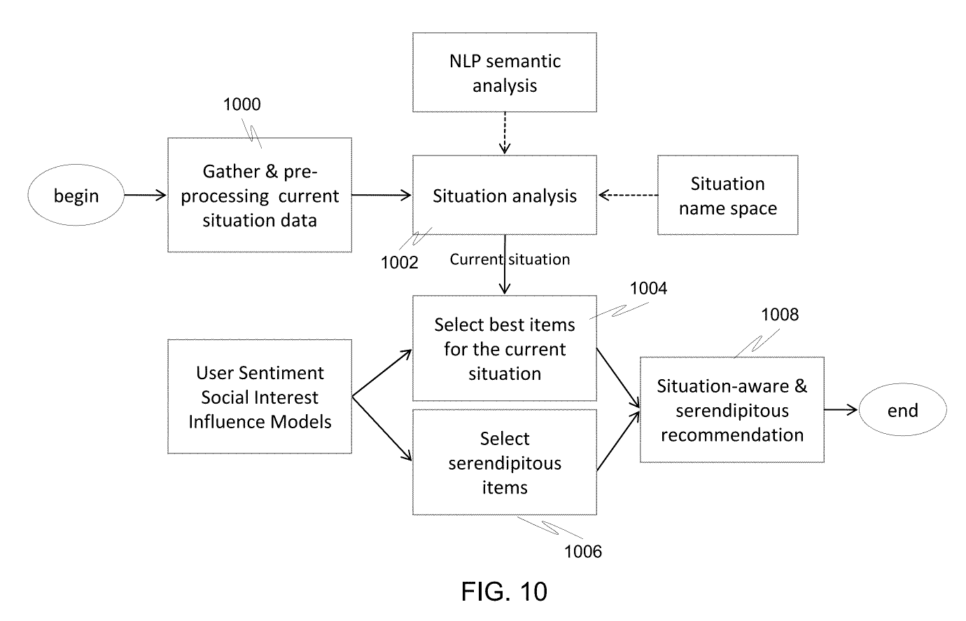

FIG. 10 depicts recommendation in accordance with an embodiment of the present invention. It should be noted that the components shown in this figure are many of the same components shown in FIG. 2, and as such, the discussion of FIG. 2 above is applicable here as well. This shows how to use the models for predicting user needs and making predictive and serendipitous recommendations. At the time of the recommendation, the system first gathers the current situation data 1000, and derives the user's current situation 1002. It then queries 1004 the models to get the user's interests, sentiments, and influences in similar situations. It then ranks and selects the top few concepts to be recommended based on the current situation. Meanwhile, it can select items from the user's long-term interests, situation-independent interests, and from the profiles of the people who have similar interests for serendipity. Box 1008 then mix the items selected by box 1004 and 1006, ranks the results and displays them to the user.

The system depicted in FIG. 2 can be realized in various ways. In a first embodiment, all components reside in the same device, such as a phone, tablet, laptop, etc. In a second embodiment, a client device runs the situation-aware user activity tracker and sends the data to be stored on a server or in a cloud. The user model construction and update module runs on the server or in the cloud. At recommendation time, the client device identifies the current situation, and asks the server/cloud to identify the items for recommendation. In a third embodiment, the long-term interests and social relations, latent patterns, and similar users can be cached on the client device, with the client device identifying the items for recommendation. Of course, one of ordinary skill in the art will recognize there may be other ways to partition the functions without violating the spirit of the invention.

The models may also be stored in various forms. In one embodiment, they are encoded and stored using standard semantic web technology, such as using RDF. Alternatively, the models can be stored using database technology or other semi-structured XML-based technologies. The recommenders can access/interact with the models using the technology consistent or interoperable with the encoding/storing technology.

As will be appreciated to one of ordinary skill in the art, the aforementioned example architectures can be implemented in many ways, such as program instructions for execution by a processor, as software modules, microcode, as computer program product on computer readable media, as logic circuits, as application specific integrated circuits, as firmware, as consumer electronic device, etc. and may utilize wireless devices, wireless transmitters/receivers, and other portions of wireless networks. Furthermore, embodiment of the disclosed method and system for displaying multimedia content on multiple electronic display screens can take the form of an entirely hardware embodiment, an entirely software embodiment, or an embodiment containing both software and hardware elements.

The term “computer readable medium” is used generally to refer to media such as main memory, secondary memory, removable storage, hard disks, flash memory, disk drive memory, CD-ROM and other forms of persistent memory. It should be noted that program storage devices, as may be used to describe storage devices containing executable computer code for operating various methods of the present invention, shall not be construed to cover transitory subject matter, such as carrier waves or signals. Program storage devices and computer readable medium are terms used generally to refer to media such as main memory, secondary memory, removable storage disks, hard disk drives, and other tangible storage devices or components.

Although only a few embodiments of the invention have been described in detail, it should be appreciated that the invention may be implemented in many other forms without departing from the spirit or scope of the invention. Therefore, the present embodiments should be considered illustrative and not restrictive and the invention is not to be limited to the details given herein, but may be modified within the scope and equivalents of the appended claims.

What is claimed is:

1. A method of constructing user models from user usage and context data, the method comprising:
constructing a personal interest graph including interests derived from usage data of the electronic device, with nodes of the personal interest graph representing interests of the user, and wherein the nodes also contain information about a degree of user interest in the corresponding interest and a sentiment of the user at the time when the usage data suggests that the user expressed interest in the interest, wherein the sentiment is determined by analyzing input from one or more sensors on the electronic device;
modifying the personal interest graph by annotating one or more nodes of the personal interest graph with influence information, wherein the influence information contains a pointer to another user who influences the user on the interest represented by the corresponding node and a degree of influence of the another user on the user for this interest;
determining a current sentiment for the user by analyzing input from one more sensors on the electronic device; and
locating a node that contains a sentiment that is similar to the current sentiment and that has the highest combination of degree of user interest.

2. The method of claim 1, wherein the locating a node also examines degree of influence of another user for a node when determining which node to locate.

3. The method of claim 1, wherein the one or more sensors includes a hardware sensor.

4. The method of claim 3, wherein the hardware sensor is a global positioning system (GPS) module.

5. The method of claim 3, wherein the hardware sensor include an accelerometer.

6. The method of claim 3, wherein the hardware sensor includes a camera.

7. The method of claim 3, wherein the hardware sensor includes a microphone.

8. The method of claim 3, wherein the hardware sensor includes a heart rate monitor.

9. The method of claim 3, wherein the hardware sensor includes a skin conductance measuring device.

10. The method of claim 1, the one or more sensors includes a software sensor.

11. The method of claim 10, wherein the software sensor includes a domain-independent sentiment analysis tool.

12. The method of claim 10, wherein the software sensor includes a weather application.

13. The method of claim 10, wherein the software sensor includes a natural language programming semantic analysis component.

14. The method of claim 10, wherein the software sensor includes an email analysis module.

15. The method of claim 10, wherein the software sensor includes a social networking site monitor.

16. The method of claim 10, wherein the software sensor includes a web browsing monitor.

17. The method of claim 1, further comprising pre-processing the usage data and the input from one or more sensors prior to the constructing of the personal interest graph.

18. The method of claim 1, wherein the personal interest graph is a subset of a global topology constructed by a natural language programming semantic analysis component.

19. The method of claim 1, wherein sentiment includes user emotional state.

20. The method of claim 2, wherein the degree of influence of the another user is based on a number of posts the another user has made on a social networking site.

21. The method of claim 2, wherein the degree of influence of the another user is based on a number of followers of the another user.

22. The method of claim 2, wherein the degree of influence of the another user is based on ratings of posts of the another user from a social networking site.

23. An electronic device comprising:
a situation-aware user activity tracker including:
a situation data gathering and pre-processing module;
an activity data gathering and pre-processing module;
a situation name space component;
a situation analysis module;
a user model construction/update module including:
a social modeling component;
an interest modeling component;
an influence analysis module;
a sentiment analysis module;
a natural language programming semantic analysis module; and
a data storage coupled to the situation-aware user activity tracker and the user model construction/update module.

24. The electronic device of claim 23, wherein the electronic device is a mobile phone.

25. An apparatus comprising:
means for constructing a personal interest graph including interests derived from usage data of the electronic device, with nodes of the personal interest graph representing interests of the user, and wherein the nodes also contain information about a degree of user interest in the corresponding interest and a sentiment of the user at the time when the usage data suggests that the user expressed interest in the interest, wherein the sentiment is determined by analyzing input from one or more sensors on the electronic device;
means for modifying the personal interest graph by annotating one or more nodes of the personal interest graph with influence information, wherein the influence information contains a pointer to another user who influences the user on the interest represented by the corresponding node and a degree of influence of the another user on the user for this interest;
means for determining a current sentiment for the user by analyzing input from one more sensors on the electronic device; and
means for locating a node that contains a sentiment that is similar to the current sentiment and that has the highest combination of degree of user interest.

26. A non-transitory program storage device readable by a machine tangibly embodying a program of instructions executable by the machine to perform a method of constructing user models from user usage and context data, the method comprising:
constructing a personal interest graph including interests derived from usage data of the electronic device, with nodes of the personal interest graph representing interests of the user, and wherein the nodes also contain information about a degree of user interest in the corresponding interest and a sentiment of the user at the time when the usage data suggests that the user expressed interest in the interest, wherein the sentiment is determined by analyzing input from one or more sensors on the electronic device;
modifying the personal interest graph by annotating one or more nodes of the personal interest graph with influence information, wherein the influence information contains a pointer to another user who influences the user on the interest represented by the corresponding node and a degree of influence of the another user on the user for this interest;
determining a current sentiment for the user by analyzing input from one more sensors on the electronic device; and
locating a node that contains a sentiment that is similar to the current sentiment and that has the highest combination of degree of user interest.
